(19) United States
(12) Patent Application Publication
(10) Pub. No.: US 2021/0326994 A1
(43) Pub. Date: Oct. 21, 2021

(54) Method and System for Value Transactions

(71) Applicant: Sherry Dang, Watsonville, CA (US)

(72) Inventor: Sherry Dang, Watsonville, CA (US)

(21) Appl. No.: 17/087,449

(22) Filed: Nov. 2, 2020

Related U.S. Application Data
(63) Continuation-in-part of application No. 16/850,809, filed on Apr. 16, 2020.

(51) Int. Cl. G06Q 40/08

(52) U.S. Cl. CPC G06Q 40/08

(57) ABSTRACT

A system implementing property insurance has an Internet connected server, a web site providing a plurality of interactive interfaces, one of the interfaces facilitating registering as a member by individual insurance companies and by individual insured persons, using Internet connected platforms, profiles of the insurance companies and the insured persons, a separate insurance vault associated with each one of the insured persons, each insurance vault storing names, descriptions and values for items of property owned by the insured person, there being one insurance vault for each registered insured person, and a communication tool enabling individual ones of the registered insurance companies, through authorized agents, to exchange messages with individual ones of the insured persons who are insured by the registered insurance company. Through the communication tool, insurance companies communicate with insured persons, negotiating agreement on issues regarding insurance coverage for items in the insurance vaults.

### CROSS REFERENCE OF RELATED DOCUMENTS

The present application is a continuation in part (CIP) of co-pending application Ser. No. 16/850,809 filed on 16 Apr. 2020. All disclosure of the parent application is incorporated at least by reference.

### BACKGROUND OF THE INVENTION

### 1. Field of the Invention

The invention is in the technical area of providing alerts and relates more specifically top alerting beneficiaries of insurance policies of events that trigger claimable insurance benefits.

### 2. Description of Related Art

The present inventor has discovered that benefits of many insurance policies, such as life insurance policies, go unclaimed. The inventor concludes that this must be because beneficiaries of policies with unclaimed benefits are simply unaware that (a) there is a policy (b) a beneficiary named in the policy is not aware of being named as a beneficiary, (c) the beneficiary isn't aware that an insured person may have passed. Thus, many beneficiaries simply let their benefits go unclaimed.

Further to the issue of insurance benefits, there are many other circumstances in which benefits may flow, under limited circumstances, from one person or enterprise to another person or enterprise under specific circumstances. A will is one example. Another example is distribution of assets in dissolution of a business or other enterprise. There are a great many such circumstances.

Further to the above, there seems to be in the art no service whereby a person, perhaps in the later stages of life, may be sure that their assets may be distributed to exactly those to whom they prefer, and that even such as message and the like may also be sent to specific people in the event of death of the subject.

Another unmet need in the technology is a secure and reliable system whereby insured persons and insurance companies may collaborate in instantiating and maintaining an virtual insurance vault wherein value of insured property may be reliably determined, and processes may be carried out in insurance transactions.

Therefore, what is needed is a system and method wherein individuals and insurance companies may dialogue on an insurance vault securely storing documents, descriptions of assets and valuables, along with tools to populate the vault and edit the vault at need.

### BRIEF SUMMARY OF THE INVENTION

In an embodiment of the invention a system implementing property insurance is provided, comprising an Internet connected server executing software from a non-transitory medium, a web site providing a plurality of interactive interfaces through execution of the software, one of the interfaces facilitating registering as a member by individual insurance companies and by individual insured persons, using Internet connected platforms, profiles recording information regarding individual ones of the insurance companies and individual ones of the insured persons, a separate insurance vault associated uniquely with each one of the insured persons, each insurance vault storing names, descriptions and values for items of property owned by the insured person associated with the insurance vault, there being one insurance vault for each registered insured person, and a communication tool enabling individual ones of the registered insurance companies, through authorized agents, to exchange messages with individual ones of the insured persons who are insured by the registered insurance company. Through the communication tool, insurance companies communicate with insured persons, negotiating agreement on issues regarding insurance coverage for items in the insurance vaults.

In one embodiment of the invention the communication tool comprises a chat server accessed through the communication tool, whereby insured persons and insurance companies negotiate. Also, in one embodiment communication via the communication tool is accomplished via email, text or telephone. In one embodiment the system has an upload tool enabling insured persons to image individual articles and to upload the images to an insurance vault associated with the insured person instantiating each article in the insurance vault. And in one embodiment upload tool further enables the insured persons to name and describe the individual articles imaged, and for which images are uploaded to insurance vaults.

In one embodiment the upload tool further enables the insured persons to attach a value to each individual article instantiated in an insurance vault. Also, in one embodiment the upload tool further enables the insured persons to upload evidence of value for each article instantiated and valued in the insurance vaults. In one embodiment registered insurance company and registered insured member is issued a Vcode, the Vcode associated uniquely with an insurance vault. In one embodiment members enter their associated Vcode on logging in, focusing functionality on associated insurance companies and insured members. And in one embodiment the system further comprises a search function enabling registered members to find, access and edit files in individual ones of the insurance vaults.

In another aspect of the invention a method implementing property insurance is provided, comprising registering insurance companies and insured individuals using Internet connected platforms as members of an insurance service hosted as a web site by a Vault enterprise through an interactive interface provided by executing software on an Internet connected server, recording profiles providing information regarding individual ones of the insurance companies and individual ones of the insured persons, instituting a separate insurance vault associated uniquely with each one of the insured persons, each insurance vault storing names, descriptions and values for items of property owned by the insured person associated with the insurance vault, there being one insurance vault for each registered insured person, and providing communication by a communication tool between individual ones of the registered insurance companies, through authorized agents, with individual ones of the insured persons who are insured by the registered insurance company, enabling the agents and insured persons to exchange messages in negotiation agreement on issues regarding insurance coverage for items in the insurance vaults.

In one embodiment the method comprises negotiation through a chat server accessed through the communication tool. Also in one embodiment the method accomplishes negotiation through via email, text or telephone. In one embodiment the method comprises uploading images of individual articles to an insurance vault associated with the insured person, instantiating each article in the insurance vault. And in one embodiment the method comprises naming and describing the individual articles instantiated in an insurance vault.

In one embodiment the method comprises recording a value for each individual article instantiated in an insurance vault. Also in one embodiment the method comprises recording evidence of value for each article instantiated and valued in the insurance vaults. Also in one embodiment the method comprises issuing a Vcode to each registered insurance company and ach registered insured member, the Vcode associated uniquely with an insurance vault. In one embodiment members enter their associated Vcode on logging in, focusing functionality on associated insurance companies and insured members. And in one embodiment the method further comprises searching the insurance vault, and accessing and editing files found in searches.

### BRIEF DESCRIPTION OF THE SEVERAL VIEWS OF THE DRAWINGS

FIG. 1 is an architectural diagram for a system in an embodiment of the present invention.

FIG. 2 is a depiction of a home page for an enterprise practicing an embodiment of the present invention.

FIG. 3 is an interactive interface page for registration in an embodiment of the invention.

FIG. 4 is a configuration page in an embodiment of the invention.

FIG. 5 is an alternative configuration page in an embodiment of the invention.

FIG. 6 is a flow diagram illustrating a process in practice of an embodiment of the present invention.

FIG. 7 illustrates steps in a process of registering to a Vault enterprise and instantiating an Insurance Vault by a person or an enterprise.

FIG. 8 illustrates apparatus and process by which a registered ember may populate that member's Insurance Vault.

FIG. 9 is a diagram representing three different insurance enterprises as members of the Vault domain and association with eight members who have Insurance Vaults maintained in the enterprise.

### DETAILED DESCRIPTION OF THE INVENTION

The inventor in the present application has discovered an unmet need that the present invention has been implemented to fill. The inventor has created a system termed by the inventor Vault4Life, which enabled individuals to register to Vault4Life as a secure service, and to store with that service any type of file—from photos and videos to financial information—and access it easily anytime, anywhere. Documents stored may include, for example, credit card agreements, mortgages, all sorts of assets and debts—in short, all important information regarding a registered member. The stored files may include benefits of several sorts, and triggers that may release benefits. A registered user may create a bucket list and write final wishes for a funeral and a digital legacy, so loved ones are not left with difficult choices to make. An important feature is that the stored documents may be edited and updated, including triggers and beneficiaries, without resort to outside counsel or legal aid.

In Vault4Life a registered user may create online photo albums wherein one may store and organize digital photos online, in a personal secure cloud. Photos are stored in a state-of-the-art data center to offer complete protection from computer crashes and viruses.

In the Vault4Life system standard cloud storage features are provided, such as securing documents, accessing files from any device, offline access by syncing files to a device, and backup and disaster recovery.

There are many things that one may wish to accomplish in a lifetime. Unfortunately, quite often many of the wishes are left undone. Vault4Life has a Bucket List feature motivates a member to really achieve all life goals.

A registered user may add beneficiaries to a registered account that will ensure that loved ones can access the member's personal information after the member may have passed away. This feature also ensures that final wishes will be carried out and the photos and messages that are left behind will be saved as valuable memento by loved ones.

There is a Burial and Memorial Preparations feature allowing members to record last wishes. This feature ensures that loved ones know the member's last wishes after death.

Another feature enables a registered member to leave all social media user id, pass code and instructions to keep social media accounts going or to shut them down.

In some embodiments of the invention a member has an ability to use artificial intelligence tools and machine learning to find potential benefits, such as credit card agreements, mortgages, and so on. There may also be an ability to flag a social media account and other accounts, that a member has passed away, and in some circumstances close such accounts. There may in some embodiments also be an ability to archive history into the vault from any social media sites that have the ability to do so. In some embodiments there may also be functionality for an account associated with a specific member, to be transferred to another person when and if the member passes. Further, there may be functionality for an account to stay open simply as a memorial to the member that has passed, and some or all of the saved content may be available to specified persons.

The Vault4Life system is a secure online storage space that allows storing personal or other important data safely. To ensure that personal data is protected, the data is stored in the cloud in a secure online location, making data accessible wherever the member may be. Further detail regarding security is described below.

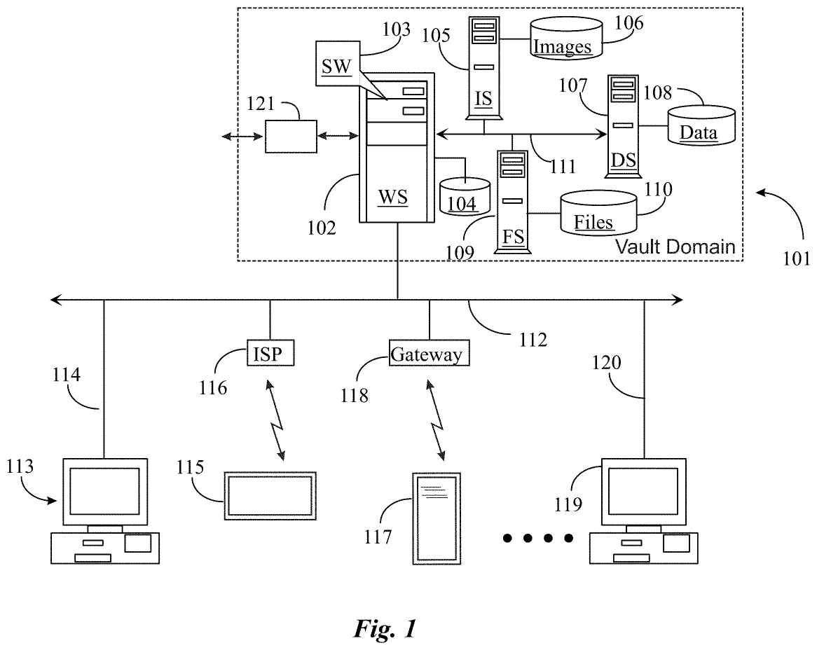

FIG. 1 is an architectural diagram for a system in an embodiment of the present invention. In one embodiment of the system a Vault Domain 101 is created, comprising a Web Server 102 connected to the well-known Internet network, represented by backbone 112, which is meant to include all networks, subnetworks, core routers, edge routers and the like that make up the Internet network.

Web Server 102 executes Software (SW) 103 which may provide management, interactive interfaces for users employing computerized appliances connected to the Internet to register and transact with the system, storage of documents and the like. In one embodiment there may be in Vault Domain 101 one or image servers 105 storing and retrieving images from a repository 106, one or more file servers storing and retrieving files from a repository 110, and one or more data servers 107 storing and retrieving data from a repository 108. In some embodiments, images, files and data may be handled by a single server to and from a single repository.

Vault domain 101 additionally has communication apparatus 121 that includes at least one cellular network connection, and optionally a landline telephone connection, to facilitate communication in operations that may be directed by SW 103.

Vault Domain 101 is accessible on the Internet from, for example, users operating computer platforms represented by computer 113, through connection 114 to the Internet, which may be accomplished a in a variety of ways as known in the art. A user may also employ a pad device 115 accessing the Internet via an Internet Service Provider (ISP) 116, or which a variety are known in the art. A user may also employ a mobile device, like smartphone 117 accessing the Internet via a cellular network through a gateway 118. Computer 119 is included to show that there may be many more computerized appliances that may connect users to Vault Domain 101.

In the Vault system, in embodiments of the present invention, a registered user, an individual or an enterprise, may register to become a member of the system, and by doing so enable access to services provided. Interaction with the Vault system is through interactive interfaces provided on displays of the computerized appliances employed by members, like appliances 113, 115 and 117 through any one of several Browser applications available to the public, like, for example, Mozilla Firefox.

### Security Features

In an embodiment of the invention:
SSl Certificate By www.digicert.com
An SSL certificate is applied for www.vault4life.net generated by www.digicert.com which provide high encryption SSL certificates to BANK's.
The total connection will be encrypted from user end to the Server.
Will use TLS_AES_128_GCM_SHA256, 128bit keys, TLS 1.3 certificate.

### Site Lock Implementation

SiteLock is implemented on www.vault4life.net website.
Makes it more secure to use.
All the data which is uploaded by end users is checked for any kind of Malicious Code, Scripts, Malware Infections and Viruses.
Rejects uploading of Harmful Softwares.
Automatically guards website from bad bots and Cyber threats.

### Separate Database From Main Server

Creation of Separate Database Server.
Hackers usually inject database queries after freezing the website to manipulate and fetch data from server.
Web Server and Database Server must be different.
   Close unused Ports and use secure Connection
Close all the Non-Required TCP/UDP ports from the server.
Some TCP/UDP ports are open by default, which are not required mostly.
Need to close them all except for very few ports which are used to connect between two or more servers for data exchange.
Change port numbers which are being used by default.
For Example: port 22 is used for SSH to Linux server by default, we can change it and allow SSH connection to port 2222.
   Separate Data Server from Main Server
Separate Data Server which contains User data from Main Server.
All the Servers are connected to each other by SSH keys.

### Backup Server

Backups run on hourly basis and daily basis for security of users data.
Backup server also contains daily and hourly database backups of all users.
   Token System with Session Layer
Specific Token are allotted to every user for specific time period.
Token is allotted to user when user logins to the portal and after logout the token will be destroyed.
Validation process is applied to token for checking that if the user is valid or someone tries to forcefully login.
Session Layer is added for more security purposes.
Current session expires after every 2 minutes of non-usage.

### Firewall

All Servers are behind a firewall to protect from unauthorized access.
We can also allow the selected number of users at a time.
With firewall we can block all the unauthorized IPs from which users tried to login with fake Identity.
We can also control traffic on the website.
   2 factor authentication
Two factor authentication allows two way verification while login to the account.
Reduces risk of unauthenticated users to login into someone's account.
SMS sent to user's registered mobile number or email ID which will contain OTP.

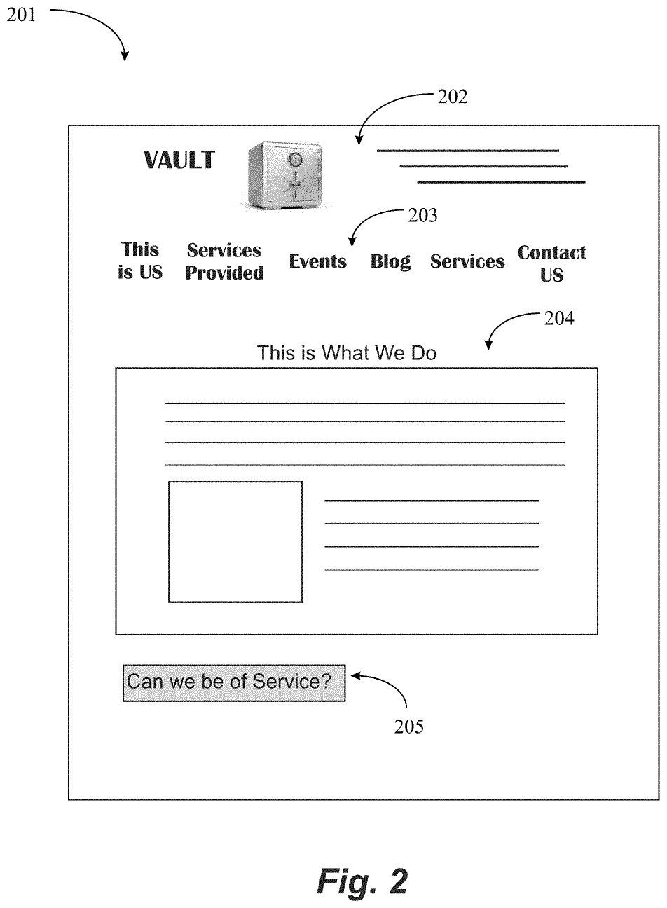

FIG. 2 is an exemplary Home Page 201 for the Vault domain in an embodiment of the invention. This is merely an example of what a home page for this unique service might illustrate and enable. The person of ordinary skill in the art will understand that in practice the Home page for this service may be considerably different, and FIG. 2 is merely exemplary. In essence there may be a header section 202 with the name of the Vault enterprise and contact information. A command line 203 may provide interactive links to navigate to alternative pages in the site. An explanatory portion 204 may provide high-level description of services offered, and advantages of the service. An interactive link 205 may direct a person to a registration page.

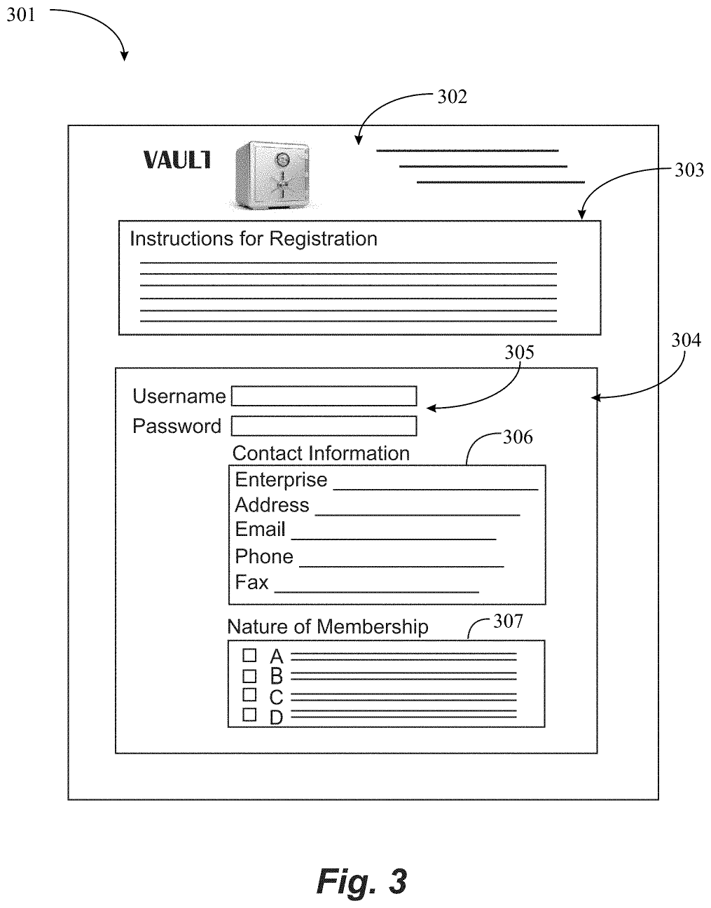

FIG. 3 is an example of a registration interactive interface 301 enabling registration to the Vault system. The header section is reproduced as portion 302. Instructions for registration may be presented in a portion 303. An input section 304 in this example enables a user to register, creating a username and a password in input fields 305. There may additionally be instructions for the nature of usernames and passwords that may be used. Contact information may be entered in input fields at 306.

When a user registers with the Vault system, a profile for that user is created, and becomes a directory for all input and transaction related to that user. The profile is stored in the range of repositories illustrated in FIG. 1 for domain 101.

An input section 307 enables a registering user to select a particular type (nature) of membership. There may be several different sorts of membership, determined in part by the nature of the person or the enterprise that is registering as a member. There may be one membership type, for example, for a person desiring to save an insurance policy in the Vault, with names and contact information regarding beneficiaries, nature of benefits regarding each, conditions that are set to trigger application or claim for a benefit, for example. On this particular membership there may be specific services provided, that may be different for another sort of entry into the vault. This is the motivation for different sorts of membership.

The nature may specifically related to a legal contract related to the registering user that has conditions and codicils that must be met to trigger certain actions, such as benefits that may flow from a condition being met. The contract may be, for example, a will and testament of the registering user, a life insurance policy on the life of the registering user, or another civil contract regarding distribution of benefits belonging to the registering user.

### Life Insurance

It may be that specific examples may serve to illustrate tools and functionality under different circumstances. A first example is the circumstance of a person who has contracted with an insurance carrier for a life insurance policy, paying premiums according to age, health, and amount of payout, among possibly other variables.

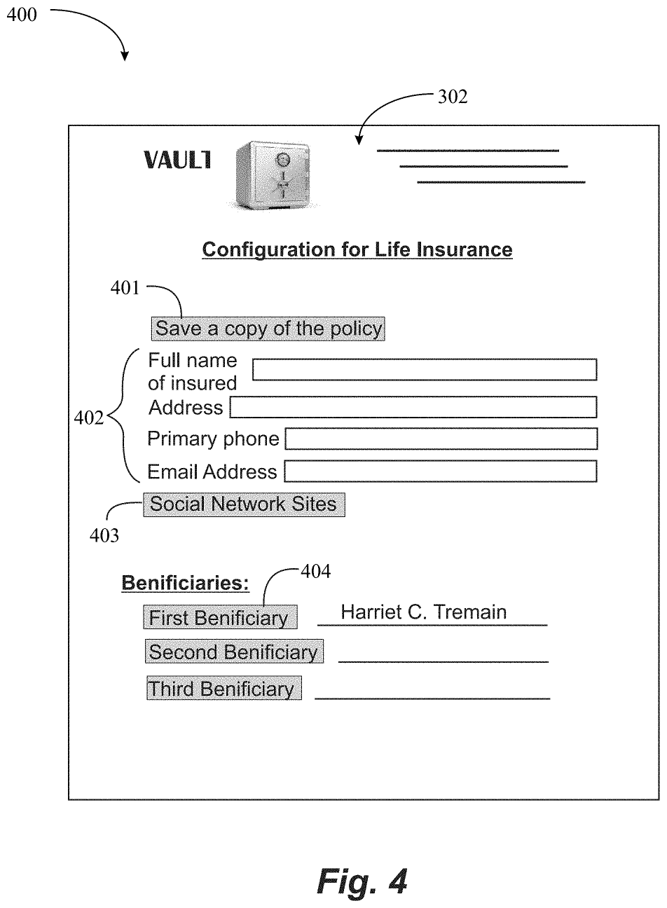

FIG. 4 illustrates a configuration page 400 for a person or an enterprise who has registered for services and has elected a “nature of membership” at input 307 in FIG. 3. Individuals may register and elect services for a person life policy, and enterprises, for example, may choose to insure a CEO or other manager.

A user who elects to register and use the services of the Vault will in one embodiment, after electing a “Nature” in FIG. 3, be directed to a configuration page, one example illustrated as FIG. 4. Link 401 is an interactive link that opens a window for the user to upload a copy of the subject insurance policy. There may be a browse function enabling the user to locate a copy, such as a PDF copy of the policy, and to upload that to the Vault system. That copy is stored, associated with the particular user.

The user transacting for a life insurance policy, on the configuration page, is prompted to enter contact information in input fields 402. These inputs are representative, and there may be inputs requested in more detail than sown in FIG. 3, which is exemplary.

An interactive link 403 may b provided whereby the user may submit details of social networking activity, such as Facebook™, Twitter™, and others. These memberships may be useful in the system for facilitating functions after certain trigger events may occur.

An important further issue is a listing of beneficiaries of the policy. In some circumstances there may be just one, but in some circumstances there may be many beneficiaries.

In the example of FIG. 4 an interactive link 404 opens a window (not shown) that enables the user to name a beneficiary from the policy, and to input contact information much as is shown and described for the insures in section 402. When that beneficiary is entered, the name may appear on the configuration page as shown in FIG. 4. That process may be followed for other beneficiaries, if any. It is emphasized here that contact information for beneficiaries is important for further functionality of the Vault system.

In one embodiment of the invention there may be a system whereby knowledge workers at the vault site shown as domain 101 in FIG. 1 may review the insurance policy uploaded through link 401 of FIG. 4, and make all the entries required for the configuration, relieving the insured from that task. In another embodiment fillable forms may be provided to the user, that may be filled offline, and then provided to the domain.

### Wills

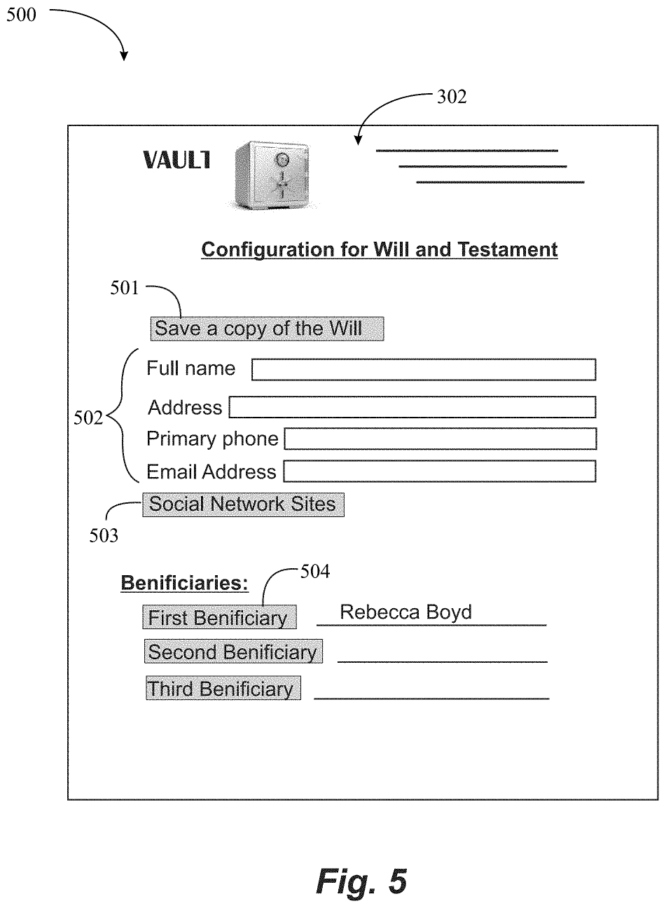

A registering user may elect in FIG. 3 Type “B”, which in one embodiment may be dedicated to a storage and implementation of codicils of a Will and Testament for the user. In this circumstance a configuration page shown as FIG. 5 may be displayed to the user for input.

FIG. 5 illustrates configuration page 500 for a user entering a Will and Testament for following by the Vault. This configuration is much the same as for an insurance policy. The user may enter a copy of the will using link 501, and may nter all of the necessary profile information in the input field 502. Further information, such as social networking memberships may be entered through link 503. Beneficiaries are entered, and contact information for beneficiaries entered through links 504. There may be, in the case of a will, rather than an insurance policy, many more beneficiaries.

As described above, in some embodiments, knowledge workers at the Vault site may work with a will entered, and input all of the necessary information.

### Other Contracts

Functionality of the Vault is not limited to wills and insurance policies. There may be other circumstances wherein a person or an enterprise may wish to store knowledge of ownership or interest in one or more valuable articles or commodities, and set up trigger events such that third parties may be notified upon occurrence of a trigger event, to take some action regarding the subject articles or commodity.

Configuration pages may be devised for these circumstances, much like the configuration pages for wills and insurance policies, and owner or interested party may set trigger events.

An important feature of the invention is to determine when and if a trigger event has taken place, and to initiate and carry out notification of listed beneficiaries. In the case of a life insurance policy and a will and testament alike, the trigger event may be verified death of the policyholder or the subject of the will.

In one embodiment of the invention every registered user is tracked as to access to the system. Members are expected to log in at least once in every 60 days to let admin. of Vault4Life know that they are still active. If a member does not log in, admin will send out email or text to ask remind member. Admin will do this 3 times for 3 months, then begin to contact beneficiary.

In embodiments of the invention, for each will, policy or valuable commodity associated with a registered member, once configuration is complete, a set of preprogrammed coded instructions may be automatically associated with that commodity. These sets of functions may be common for each sort of circumstance and differ primarily only in the data associated with the member, the commodity, and the potential beneficiaries.

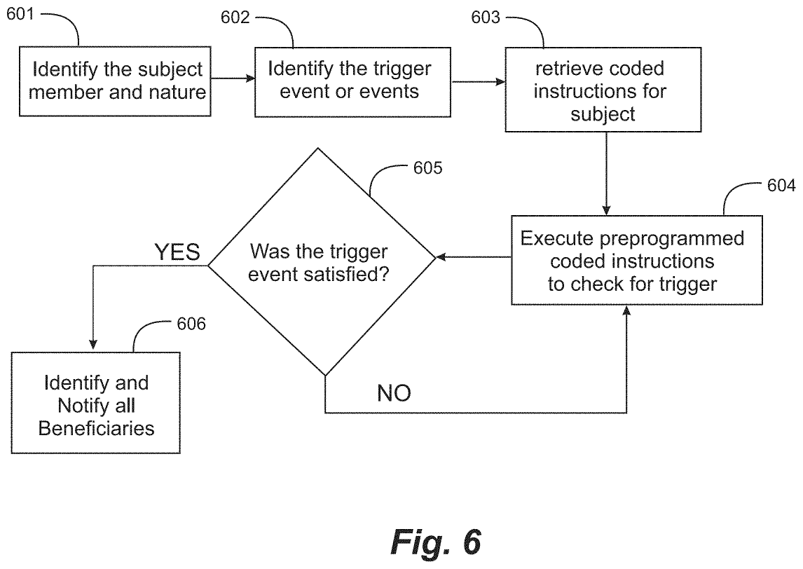

FIG. 6 is a flow diagram illustrating a process implemented by coded instructions in functionality of the Vault system, for determining occurrence of trigger events, and notifying beneficiaries, and potential beneficiaries to make inquiries about a benefit. This or a similar process may be conducted for each stored policy, will or commodity instantiated in the Vault system. In one embodiment the process is initiated when configuration is complete. There may also be a configuration to set frequency for performing the trigger determination process of FIG. 6. It is not necessary to waste computer resources to perform this process continuously for every instance of a will or policy, for example. It may be adequate to perform the process, for example, once per week, and computer resources may be preserved by staggering dates of performance for different instances.

At step 601 the system identifies a subject member and the nature of the membership. That is, whether the nature is a will, an insurance policy, or some other valuable commodity. At step 602 the trigger event or events are identified. At step 603 the preprogrammed coded instructions for this particular subject are retrieved. And at step 604 the coded instructions are executed.

It must be emphasized that the operations under step 604 may be many and varied. In the example of a registered member having saved a life insurance policy, for example, the trigger event might well be the verified death of the policyholder. It should be understood that the Vault system is not the insurance company, nor in most instances in any way associated with the insurance company. The purpose is to notify potential beneficiaries so they may inquire about benefits.

At step 604, then, the determination may be whether the subject member is still living or has passed away. In one example a person associated with the subject policy holder may simply notify the Vault system that the subject has passed. But this may be only in a minority of instances, particularly in view of the fact that there may be a long time between instantiating a policy, and the death of the subject.

In one circumstance the system may, through apparatus 121, ping the member's mobile phone once a month, or more often as time goes by. The process may also, for example, send a text with “read confirmation” set. If the phone is inactive or no one reads the text, this may be taken as a clue that the member may have passed, but further confirmation may be necessary. The process may also, or alternatively, email the member asking for a response.

In one embodiment the system may be able to track a member's location by GPS, either through the members mobile phone, or through another GPS, such as in a vehicle, to which the member has authorized access. Comparison of GPS location to residence location, along with time variables may indicate that the member may be moved to a hospital or a recovery facility, for example.

In one embodiment the process in step 604 may determine if the member's mobile phone is still in service or may be out of power or have been turned off. The system may track movement of the member's phone—if it is moving, they most likely are alive.

“Find My Phone” on Apple's iOS or Google's Location History all have the capabilities. The system may call the phone and listen for certain words. Often, if calling someone's phone and it rings only once then goes to voicemail or gives a message saying something like “the person you have called is unavailable right now,” that's a sign the phone is off or in an area with no service. The system might make this call once per day for a predetermined number of days and make a determination that way. Also, if the person is using social media on their mobile phone then the App can tell if they are active or not.

The system may seek permission either at the time of configuration, or later, to query the user's mobile provider, as to whether the phone is still active. If tracking history has certain patterns, and pattern cease and the phone is mobile, that can be an indication of a serious change.

In one embodiment there may be a combination of the conditions sought as described above to make a high percentage probability that the user has passed. The final determination may be a canvas, for example, of funeral homes in a general area of the residence of the subject user, to see if a funeral has been scheduled or has taken place. A canvass of obituaries of local newspapers may be done as well.

The processes described here to determine if a person has passed are related to policies and wills, not necessarily to some other sorts of artifacts that may be stored and tracked. In individual cases the processed for step 604 may be configured as needed. At step 605, the system determines if the trigger event is satisfied, in this example, whether the member having saved a policy or a will has died. If not, control goes back to step 604, and the determination process for this particular member repeats.

If the member has indeed passed, then a process at step 606 initiates to notify all beneficiaries. In some embodiments the benefit for a particular beneficiary is programmed at the time of configuration for the will or the policy. If this is the case, then the beneficiary may be notified that there is a benefit to be claimed, and also what the benefit might be. Or, alternatively, beneficiaries may be notified that a benefit may be claimed, and how the beneficiary may initiate a claim. This may be a name of a law firm or an insurance company, and a telephone number or email address to contact.

In one embodiment of the invention the Vault system may be programmed to help potential beneficiaries in making a claim, which may be predicated on a price for time, a fixed price, or a percentage of a benefit.

### Insurance Vault

In another embodiment of the invention a system and method is provided to greatly improve the process of claim adjustment and interaction in the adjustment process between insurance companies and insured individuals or enterprises.

It is well-known that at times of disaster, such as fire, flood, hurricane, earthquake, burglaries and such, insurance companies and insured persons have to jointly go through a complicated and lengthy claim adjustment process. At the time of a serious loss in a natural disaster insured persons are already under great stress, and the adjusters and others in insurance companies are likewise under pressure. The load on insurance companies is such that there is an industry of adjusters who work as consultants.

A big problem in the claim adjustment process is reaching agreement between the insurer and the insured as to what was lost, what the value is, and what is the financial responsibility of the insurer. The system and method in this embodiment of the invention saves time, and also minimizes inaccurate claiming.

It is well known in the art that nearly all homeowners and most apartment dwellers have insurance on personal property. There is a typically feeling of comfort just in the fact that a policy exists. Too often, once a loss occurs, especially a loss in a natural disaster, the comfortable feeling disappears in the face of a contentious process of coming to agreement on the actual lost articles and the value of same.

Some people keep a good record of property, and diligently keep the record accurately updated. These people are in a substantial minority. Features of the instant invention provide a way to vastly improve this process.

A very important feature of the invention in this embodiment the inventor terms “Insurance Vault” is a data record on behalf of an insured person, group of people or enterprise. This insurance Vault is provided with storage and tools at a website hosted by an enterprise, termed the Vault Enterprise in this description. Reference is made again to FIG. 1 which illustrates an architecture that persons and enterprises with Internet access may employ to institute an Insurance Vault.

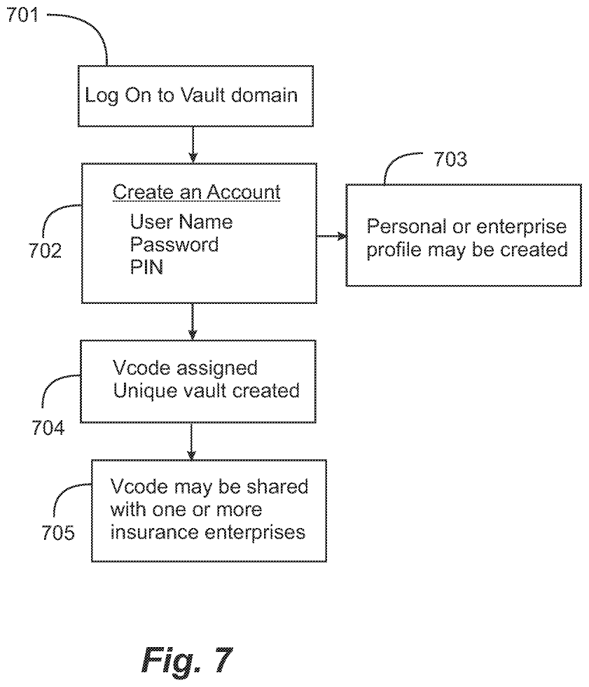

FIG. 7 illustrates steps in a process of registering to a Vault enterprise and instantiating an Insurance Vault by a person or an enterprise. The skilled person will understand that the process will be performed by a person in any case, but the person may be authorized to act for a group of persons forming an enterprise, which may be a business, religious group, non-profit organization, or any other enterprise.

At step 701 a person navigates to a web site hosted by the Vault Enterprise, where a welcome page may be presented, which may explain to some extent the nature and purpose of the enterprise, and may provide instruction for registration. At step 702 the person registers by creating a Use Name, a Password and in some instances a PIN number. In some circumstances a personal or enterprise portfolio may be created at step 703. In this circumstance more detailed information may be recorded, and a user may be enabled to indicate which information may be shared and which may not.

At step 704 the system creates a unique Vcode and assigns the Vcode to the person or enterprise that has registered. This Vcode is associated uniquely with a unique Insurance Vault, which may be defined as a digital record, the content of which is described in additional detail below. In some circumstances the Vcode assigned to a person or enterprise and to the Insurance Vault associated with that person or enterprise may be shared with an insurance enterprise, and that circumstance is described in additional detail below as well.

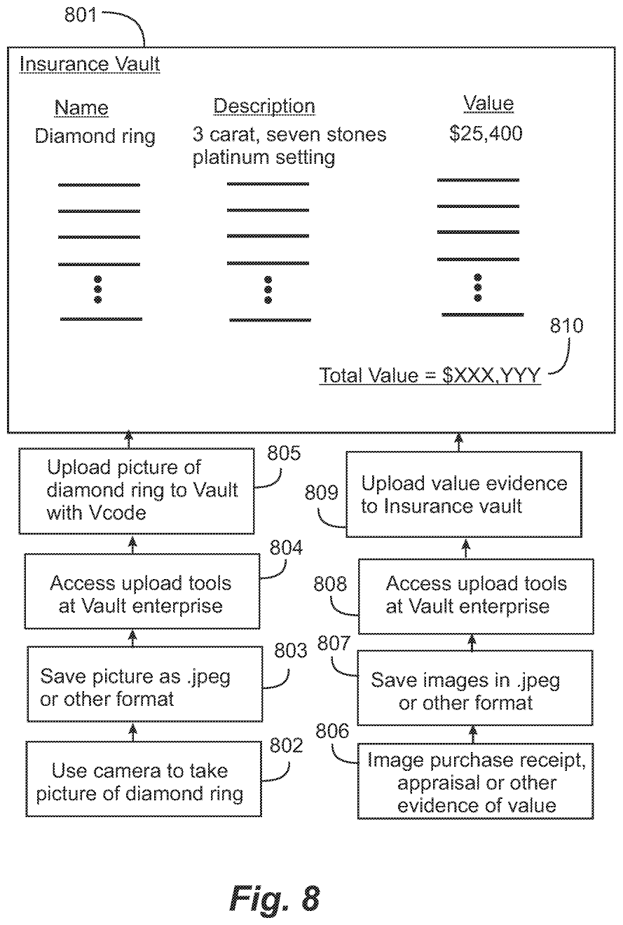

FIG. 8 illustrates apparatus and process by which a registered member may populate that member's Insurance Vault. This process of populating the vault is an inventory of all the items of value that may be insured by an associated insurance company. A representation of an Insurance Vault for a single user is shown as element 801. Exemplary contents are a listed diamond ring, with a description of the ring and a value. Additional lines represent other objects that are content as property with names, descriptions and value.

Beginning a step 802 a user may use a camera, perhaps with smart phone, to take a picture of a diamond ring. At step 803 the picture is saved as a .jpeg or in another format. At step 804 the user may log into the Vault domain and access upload tools, which may be done through first identifying the user, then choosing the correct Vault by the Vcode, then tools may be accessed. At step 805 the user uploads the picture of the diamond ring to the Insurance Vault associated with that user.

The skilled person will understand that the architecture illustrated in FIG. 1 may be involved in user interaction with the Vault domain. Also, not all tools are described and illustrated here. The user may for example, elect to enter a description for the diamond ring or other named object uploaded to the Insurance Vault, and may do the same for other objects entered as content in the Vault. In one embodiment the names, descriptions and values displayed in a Vault may all be links which, when accessed may allow the authorized user to edit, add or delete content in the Insurance Vault.

In one embodiment an Insurance Vault may be subdivided into property categories, such as jewelry, kitchen appliances, furniture, floor coverings, electronics and computer equipment, TV apparatus, and more. Values may be tracked by category as well as in total. As is known in the technology, individual items, such as a rare painting, may be insured separately for an agreed to amount, and records of such agreed values are recorded.

An important feature in the evolution of contents in the Insurance Vault is evidence of value. The user, in the process of adding names, descriptions and values for objects, may also associate evidence of value. As an example, at step 806 the user may image a purchase receipt, an appraisal, or another evidence of value for an object. At step 807 the image is saved. At step 808 the upload tool is accessed. And at step 809 the evidence is uploaded to the Insurance Vault and associated with the object. So, in this example Names, descriptions and values are all entered and associated. In other embodiments history, such as date and place of purchase, including vendor may be entered and associated. In some cases data from a vendor may be included, as many jewelry enterprises, for example, keep records of jewelry with descriptions and value.

In some circumstances there may be no receipt, assessment or other reliable record of value. In such a circumstance the vault domain may provide functionality for a user, in populating the insurance vault to search the Internet for similar items to set a reliable estimate of value. In this circumstance dialogue between the insurer and the insured may be operative to reach an agreement on value. It is this value agreement between the insured and the insurer that is most desirable.

In one embodiment of the invention there may be cross communication between the Insurance Vault and The Vault4Life vault described in enabling detail above. Both may be a part of and be managed through the Vault domain. There may further be a Sentimental Vault. Objects may be moved or copied by registered members authorized to do so. Between different vaults. For example, the diamond ring described with reference to FIG. 8 above may belong to member Maxine Roberts, insured by Acme insurance, and may be copied to the Vailt4Life vault, and may be designated to Maxine's daughter Anna as beneficiary if Maxine should pass. The same diamond ring may be copied to the Sentimental Vault as a relic from Ana's Great, Great Grandmother.

The insurance vault 801, shown with individual listing of items of value, may also display total value for all items in the vault, as indicated at 810. Also, in the embodiment where the items in the vault may be grouped into categories, such as jewelry, kitchen items, and the like, there may be a total value computed and displayed for individual categories.

The skilled person will understand that the process and method of populating the insurance vault is a process that will result at some point in a fully populated vault, with values, evidence totals and the like all computed and displayable. It must be understood, however, that items may at times need to be added the contents of the vault, and items may be removed. An insured person may sell certain items or give items away. Other changes may be made as well. For example, an insured party may make valuable improvements to a home, or to another insured item, such as an automobile.

A user, having logged into the Vault domain, may select an option to edit the vault, which has tools for adding, removing, revaluing, and making changes to each and every object in the vault. At the time an insured makes changes, the associated insurance company is notified that changes have been made, and the notification may also present a list or summary of the changes that were made. As changes are made, total value computations are updated automatically.

In one embodiment insurance members are also enabled to make changes in content in a vault to which they are associated with a Vcode. If a representative of the insurance company makes a change, or proposes a change, the affected insured party is alerted, and there may be a process for dialogue between the two to make such a change initiated by the insurance company.

Referring again to FIG. 7, process steps for a user, which may be a business or other enterprise, to register and have an Insurance Vault assigned with a Vcode are described. In one embodiment of the invention insurance companies and brokers may also become members of the Vault enterprise. The registration process is similar to that for a user building an Insurance Vault, but the insurance broker will not have a separate and unique Insurance Vault, and the profile for the insurer will be different.

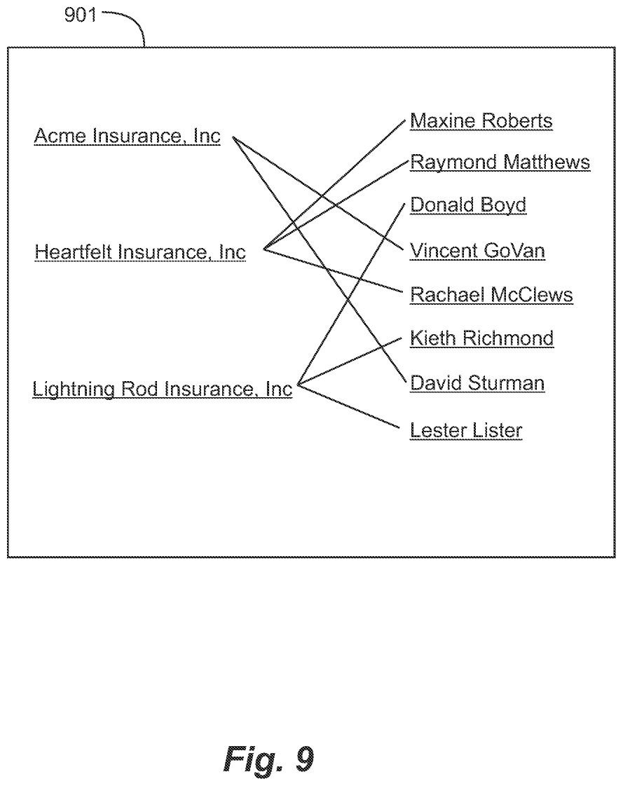

FIG. 9 is a diagram representing three different insurance enterprises as members of the Vault domain. Eight members who have Insurance Vaults maintained in the enterprise are represented on the right in this simple example. The connecting lines indicate association the insured members with insurance company members. This illustration may but may not be used as a display in the web site hosted by the Vault enterprise. Alternatively, given a displayed list of insurance company members, individual entries may be links that both display further information about the insurance company member selected, but also each insured person or enterprise that is insured by the member insurance company. List may be scrollable, and in one embodiment there may be a search function that enables authorized persons to search for insurance company members, and to display members insured by those companies.

An additional feature in an embodiment of the invention may be that for each member insured by a member insurance company, a copy of the insurance contract may be stored in the Insurance Vault of the insured party. In one embodiment this contract may be provided originally by the insurance company. In one embodiment the tools available in the Vault Domain, for both insurance company members and insured persons and enterprises, may include a system whereby insurance companies and insured persons and enterprises may negotiate and approve changes in coverage, value of insured articles, and such.

It has been described above that the Vault domain, through pages of a hosted web site, may have Tools available for members to accomplish certain functions. Different tools may be listed in a dropdown menu wherein the tool name is a link that launches functionality of the tool. One such toll may be Insurance Communication. This tool may be launched by either an insurance company or by an insured person, and upon launch the person accessing may be asked to elect certain sub-functions. As an example, Maxine Roberts may launch the Insurance Communication tool, which will have at the other end the Acme Insurance Company. There may be configuration for Maxine to implement a telephone call, an email, a text message, or a chat provided by a Chat service of the Vault Domain.

Maxine will be asked to state a purpose, or to select a purpose from a pre-programmed list, one of which may be Value of Object, for example. A representative of Acme will be notified that Maxine is seeking an audience, and the purpose is to revalue an object in her Insurance Vault. The Acme representative will elect to respond, and a dialogue will take place in which Maxine and the Acme representative may reach a new understanding on the value of a particular object in the Insurance Vault for Maxine.

In one embodiment there will be a high value group in the Insurance Vault in which objects of value over a particular threshold will be associated. The threshold may be adjustable.

There may be a variety of Tools. The communication tool, which may be termed negotiation tool, has been described. In operation different objects may be codes as “agreed to” in value. Other tools may enable a member to add objects, remove objects, add further description or images, including videos, to be associated with individual objects. In one embodiment the system may initiate a periodic interaction between insured members and associated insurance companies. The insurance companies may trigger an annual or semi-annual update, for example where insured members are requested to simply respond “satisfied” or need to negotiate. A very important purpose of the insurance Vault is to make sure that each insured member is satisfied that he/she has instantiated every object of value, and every insurance company is satisfied that the company has access to the insurance Vault, or summaries, for each insured. Another tool may enable adding objects to different vaults. Another to edit files in the Vaults. There may be a tool enabling members to search and summarize and display or download information in the Insurance Vault and other Vaults that may be a part of the Vault domain.

Once an insurance company of an insured is registered, the member and a representative of company will get a Vcode. That code may be entered when logging into the Vault domain, which will focus all functionality of the domain for the particular Insurance member and insured clients.

The skilled person will understand that the descriptions of process and apparatus above are examples, and not limiting to the scope of the invention. The invention is limited in scope only by the language of the claims.

1. A system implementing property insurance, comprising:
an Internet connected server executing software from a non-transitory medium;
a web site providing a plurality of interactive interfaces through execution of the software, one of the interfaces facilitating registering as a member by individual insurance companies and by individual insured persons, using Internet connected platforms;
profiles recording information regarding individual ones of the insurance companies and individual ones of the insured persons;
a separate insurance vault associated uniquely with each one of the insured persons, each insurance vault storing names, descriptions and values for items of property owned by the insured person associated with the insurance vault, there being one insurance vault for each registered insured person; and
a communication tool enabling individual ones of the registered insurance companies, through authorized agents, to exchange messages with individual ones of the insured persons who are insured by the registered insurance company;
wherein, through the communication tool, insurance companies communicate with insured persons, negotiating agreement on issues regarding insurance coverage for items in the insurance vaults.

2. The system of claim 1 wherein the communication tool comprises a chat server accessed through the communication tool, whereby insured persons and insurance companies negotiate.

3. The system of claim 1 wherein communication via the communication tool is accomplished via email, text or telephone.

4. The system of claim 1 comprising an upload tool enabling insured persons to image individual articles and to upload the images to an insurance vault associated with the insured person instantiating each article in the insurance vault.

5. The system of claim 4 wherein the upload tool further enables the insured persons to name and describe the individual articles imaged, and for which images are uploaded to insurance vaults.

6. The system of claim 5 wherein the upload tool further enables the insured persons to attach a value to each individual article instantiated in an insurance vault.

7. The system of claim 6 wherein the upload tool further enables the insured persons to upload evidence of value for each article instantiated and valued in the insurance vaults.

8. The system of claim 1 wherein each registered insurance company and registered insured member is issued a Vcode, the Vcode associated uniquely with an insurance vault.

9. The system of claim 8 wherein members enter their associated Vcode on logging in, focusing functionality on associated insurance companies and insured members.

10. The system of claim 1 further comprising a search function enabling registered members to find, access and edit files in individual ones of the insurance vaults.

11. A method implementing property insurance, comprising:
registering insurance companies and insured individuals using Internet connected platforms as members of an insurance service hosted as a web site by a Vault enterprise through an interactive interface provided by executing software on an Internet connected server;
recording profiles providing information regarding individual ones of the insurance companies and individual ones of the insured persons;
instituting a separate insurance vault associated uniquely with each one of the insured persons, each insurance vault storing names, descriptions and values for items of property owned by the insured person associated with the insurance vault, there being one insurance vault for each registered insured person; and
providing communication by a communication tool between individual ones of the registered insurance companies, through authorized agents, with individual ones of the insured persons who are insured by the registered insurance company, enabling the agents and insured persons to exchange messages in negotiation agreement on issues regarding insurance coverage for items in the insurance vaults.

12. The method of claim 11 comprising negotiation through a chat server accessed through the communication tool.

13. The method of claim 11 accomplishing via email, text or telephone.

14. The method of claim 11 comprising uploading images of individual articles to an insurance vault associated with the insured person, instantiating each article in the insurance vault.

15. The method of claim 14 comprising naming and describing the individual articles instantiated in an insurance vault.

16. The method of claim 15 comprising recording a value for each individual article instantiated in an insurance vault.

17. The method of claim 16 comprising recording evidence of value for each article instantiated and valued in the insurance vaults.

18. The method of claim 11 comprising issuing a Vcode to each registered insurance company and ach registered insured member, the Vcode associated uniquely with an insurance vault.

19. The method of claim 18 wherein members enter their associated Vcode on logging in, focusing functionality on associated insurance companies and insured members.

20. The method of claim 11 further comprising searching insurance vault, and accessing and editing files found in searches.
